(19) United States
(12) Patent Application Publication
(10) Pub. No.: US 2002/0111843 A1
(43) Pub. Date: Aug. 15, 2002

(54) System and method for matching employment opportunities with job-seekers using the internet

(76) Inventor: Carl J. Wellenstein, Downey, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/784,752

(22) Filed: Feb. 15, 2001

Related U.S. Application Data
(60) Provisional application No. 60/252,292, filed on Nov. 21, 2000.

(51) Int. Cl. G06F 17/60

(52) U.S. Cl. 705/8

(57) ABSTRACT

A recruitment system and methods match employment opportunities with executives using the Internet. A comprehensive recruitment system includes a Resource Consultant Component, a Executive Component, a Executive Profiles, a Recruiter Component, a Notification Component, a Executive Reply Component, a Employer Component, and a Database Component that provide executives with an anonymous way to conduct job searches and that also provide various services to small to mid-sized recruiting firms.

### BACKGROUND OF THE INVENTION

1. Field of the Invention

This invention relates generally to an employment recruitment system and, more particularly, the invention relates to methods and systems for internet-based recruitment.

2. Description of the Related Art

There are various ways a job-seeker can search and find employment opportunities. Employment opportunities can be searched by looking at advertisements in the media, by looking at postings on employers' corporate web sites, by looking at postings on the Internet job sites, or by using the services of recruiting firms.

Searching for jobs by looking at advertisements in the traditional media such as newspapers or magazines has become less popular as a result of more effective alternative channels of searching becoming available. Advertisements in the traditional media are disadvantageous in that they do not provide timely notice of the employment positions to the job-seekers. The job opening must be described, and then dispatched to the advertising department of whichever media was selected to publish the job opening. Typically, the job opening will not even be published until the next scheduled publication date. Additionally, such advertisements are normally viewed by only a limited number of subscribers, resulting in limited exposure of the advertised employment opportunities.

On the other hand, employment positions on the corporate web site are published immediately and are available for review by any job-seeker. While the publication of the employment positions is instantaneous and the employment positions are readily accessible to anyone with an Internet connection, the job-seeker must first be aware of the company's existence. The job-seeker must also have sufficient interest in the company to log onto the corporate web site before he or she can become aware of the employment positions at the company. This method also limits the exposure of the available employment positions to job-seekers. Exposure of the employment positions is important to both the employer and the job-seeker.

Various Internet job sites address the problem of limited exposure of the employment positions. Any job-seeker can log onto an Internet job site and have ready access to all the employment positions that were posted to the site without having to know of or have specific interest in any particular company. This method provides an improvement over posting employment positions on the corporate web sites for the employers since this method provides greater exposure of the employment positions to the job-seekers. However, this method also has drawbacks because no provisions exist for a job-seeker or an employer who desires to remain anonymous until mutual interest has been established. This lack of confidentiality poses particular hardship for a job-seeker at an executive-level. Employment opportunities at an executive-level are not as fungible as an employment opportunity at a less experienced level due to the special skills and experience level required for these positions. As a result, the ability to remain an anonymous candidate until mutual interest has been established may be an important criterion in the executive's job search.

Most Internet job sites require that the executive post his or her resume or respond directly to the employer or recruiter. This requirement necessitates disclosure of identity of the executive, the employer and the recruiter. As indicated above, this disclosure may not be desirable. The executive may not desire risking his or her current employer becoming aware that he or she is seeking new opportunities. The employer may also desire non-disclosure of its identity if it is seeking to replace an employee currently holding a particular position, for example. Moreover, employers often do not want their competitors to know that they are looking to employ or replace an executive.

Recruiters fill this need of providing anonymity for both the executive and the employer. An executive can become aware of the employment positions through a recruiter without disclosing his or her identity to a potential employer. The employer, on the other hand, can also post employment positions with a recruiter without disclosing its identity to the potential employee. The problem with this method, however, is that the list of employment positions and the list of executives is limited to those with whom the specific recruiter has personal contact. Hence, the recruiter must engage researchers to find and identify potential candidates from other companies, which is a time consuming and an expensive process.

There exists a need for a system and method that resolves the shortcomings of these methods.

SUMMARY OF THE INVENTION

The present invention provides a comprehensive recruitment system and methods (“System”) for matching employment opportunities with executives using the Internet.

The System provides executives with a safe and anonymous way to conduct job searches. An executive can search available employment positions without the need to prepare a resume and without having to disclose his or her identity. A wide range of job and career support and information for executives is also provided with one-stop access to training and other helpful information that they can use to resolve business problems or to enhance their careers. The System also provides valuable online resources to executives within the context of function-specific communities, for example accounting community, sales and marketing community, etc.

The System also provides various services to the small to mid-sized recruiting firms including instant access to a large pool of executives, related business-to-business services, and quality research services at a much lower price by aggregating and centralizing the research functions.

A uniquely tailored questionnaire, an Executive Profile, is utilized to enhance matching executives with appropriate employment positions. The Executive Profile, the contents of which complements, rather than duplicates information that is generally included in a resume, is used to gather the information that a recruiter needs to evaluate management skills and experience while at the same time ensuring the anonymity of the executive. The accuracy of the match between the job opening and an executive is greatly improved by the use of the Executive Profile.

In addition, the System provides automatic matching services to the executives and the recruiters. The System automatically checks new job postings with new Executive Profiles and automatically performs matching services. Thereafter, the System notifies the appropriate parties while still maintaining the anonymity of the recruiter, the employer and the executive. The System provides the means for the executive to reply to the notification that he or she received as well.

Additionally, recruiters can search and review Executive Profiles that match their specific requirements without knowing the identity of the executive, their employer or their location. Executives can also search job postings without knowing the identity of the employer or the recruiter.

Furthermore, the System provides enhancement to the quality of the matching service by providing a means to verify the information provided by the executive and to add personal interview notes to the Executive's Profile.

### BRIEF DESCRIPTION OF THE DRAWINGS

These and other features will now be described with reference to the drawings summarized below. These drawings and the associated description are provided to illustrate a preferred embodiment of the invention, and not to limit the scope of the invention.

FIG. 1 illustrates overview of the System.

FIG. 2 illustrates a sample Executive Home Page.

FIG. 3 illustrates a sample Recruiter Home Page.

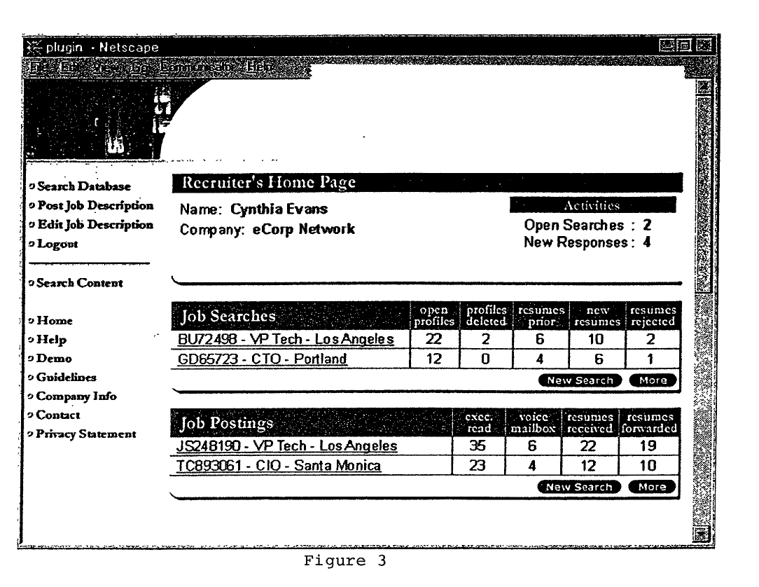

### DETAILED DESCRIPTION OF THE EMBODIMENTS

In the following description, reference is made to the accompanying drawings, which form a part hereof, and which show, by way of illustration, specific embodiments or processes in which the invention may be practiced. Where possible, the same reference numbers are used throughout the drawings to refer to the same or like components. In some instances, numerous specific details are set forth in order to provide a thorough understanding of the present invention. The present invention, however, may be practiced without the specific details or with certain alternative equivalent components and methods to those described herein. In other instances, well-known methods and components have not been described in detail so as not to unnecessarily obscure aspects of the present invention.

Reference is also made to the Appendices 1, 2, 3 and 4 in which:

Appendix 1 illustrates an example Input Instruction Pages for the Accounting Community.

Appendix 2 illustrates an example Executive Profile.

Appendix 3 illustrates an example Database-Search Template.

Appendix 4 illustrates an example Job-Posting Template.

I. SYSTEM OVERVIEW

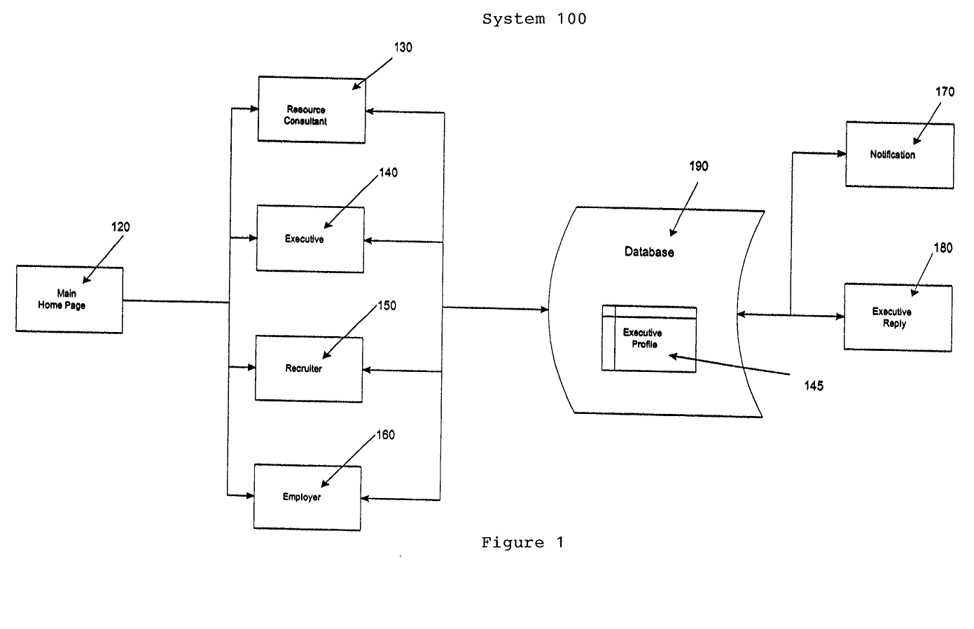

FIG. 1 illustrates overview of the System 100. The System 100 is a comprehensive recruitment system comprising a Resource Consultant Component 130, an Executive Component 140, Executive Profiles 145, a Recruiter Component 150, a Notification Component 170, an Executive Reply Component 180, an Employer Component 160, and a Database Component 190. A Main Home Page 120 provides access to the various components of the System. From the Main Home Page, a user can access other components to perform appropriate tasks.

The Resource Consultant Component 130 handles overall system functions. The Resource Consultant Component handles system functions, including handling all requests made to the System, and serves as the intermediary between the executives and the recruiters. For example, system functions include obtaining requirements for the employment positions, obtaining information regarding the Executives Profiles, and entering additional information obtained from interviews with executives whose Executive Profiles initially match with at least one employment position.

The Executive Component 140 allows executives to access the System to perform a variety of functions including accessing information regarding available employment positions and entering the executives' skills and experiences as Executive Profiles 145.

The Executive Profiles 145 allow gathering of relevant, job-specific information that facilitate effective matching of executives with employment positions. The Executive Profiles facilitate effective matching by enhancing the accuracy of matching the executives to the employment positions. The use of Executive Profiles greatly increases the probability of matching the most qualified executive to the appropriate job opening since the Executive Profiles include detailed, job-specific data regarding the executive that typically are not included in a resume.

The Recruiter Component 150 allows recruiters to access the System to perform a variety of functions including entering information regarding available employment positions, and searching and selecting among executives.

The Employer Component 160 allows employers to access the System to perform a variety of functions including selecting and using recruiters.

The Notification Component 170 accesses the Database Component 190 and compares the employment positions with Executive Profiles 145. The Notification Component sends a notification to an executive whose Profile matches the employment positions without disclosing the identity of the potential employer to maintain anonymity.

The Executive Reply Component 180 allows the executive matched to an employment position by the System to respond to the notification that he or she received and to seek additional information regarding the matched employment position. The selected executive can respond to the notification without disclosing his or her identify to maintain anonymity.

The Database Component 190 stores all information including information on the employment positions, the Executive Profiles 145 and the additional information obtained from the interviews.

The invention provides dual anonymity for both the executive and the employer. The identity of the executive is not disclosed unless and until the executive releases or authorizes the release of his or her identity. Similarly, the identities of the recruiter and employer are not released unless and until the recruiter releases or authorizes the release of the recruiter's identity and the employer's identity. This dual anonymity feature enables the executive to seek employment opportunities in complete privacy and with the confidence that no one will know the executive's identity.

Likewise, the dual anonymity feature enables the recruiter to peruse the qualifications of the available candidates in complete privacy and with the confidence that no one will know the recruiter's identity or the identity of the employer. While the anonymity on the employer's side may not be as critical as it is on the executive's side, such a feature can be critical to an employer attempting to replace key executives or wanting to keep the information from competitors, for example.

II. Resource Consultant Component

The Resource Consultant Component 130 performs the system functions. Exemplary System functions serve as the intermediary between the executive and the recruiter, handle all requests made to the System, and maintain the contents of all other Components. These system functions, as well as other system functions, are performed via the Resource Consultant Component.

The various system functions can be performed by an automated process, by various persons, or by a combination of automated processes and persons. The persons designated to perform various assigned system functions are known as Resource Consultants. The performance of these functions as well as the allocation of tasks to various parties to perform these functions are completely customizable and can vary greatly to efficiently allocate resources, both computer resources as well as human resources.

As an intermediary between the executive and the recruiter, the Resource Consultant Component 130 performs a variety of functions. For example, the Resource Consultant Component 130 requests resumes from the executives and provides additional details on any executive if requested by a recruiter by personally interviewing the executive and appending the notes from such interview to the Executive Profile 145. The Resource Consultant Component 130 acts as the intermediary to ensure anonymity to the executive, the recruiter, and the employer unless and until a mutual interest has been established and the disclosure of identities of the parties is authorized.

In the preferred embodiment, all requests made to the System 100 are handled via the Resource Consultant Component 130. An email request by an employer requesting a printed booklet on recruiting technique will be handled via the Resource Consultant Component, for example. The content and any changes or updates thereto, of all the components in the System 100 including the Executive Component 140, the Recruiter Component 150, the Employer Component 160, the Notification Component 170, the Executive Reply Component 180 and the Resource Consultant Component 130 are maintained through the Resource Consultant Component. Likewise, all data that can be entered via other components in the System 100 are accessible by the Resource Consultant Component as well. For example, Executive Profiles, resumes, text job description, and recorded job descriptions are all accessible by the Resource Consultant Component.

However, as in the case of some of the other components, access to various modules of the Consultant Resource Component 130 is controlled via the use of user ID and password. User ID and password are assigned to Resource Consultants to allow the Resource Consultants to access the Consultant Resource Component 130. The degree of access granted to any particular Resource Consultant is associated with the level of authority given to him. For example, a first Resource Consultant may only have access to modify and maintain the various Component Home Pages. A webmaster could be such a Resource Consultant. On the other hand, a second Resource Consultant may have complete access to all System functions. A systems manager could be such a Resource Consultant. By granting different levels of access to various Resource Consultants, the integrity of the data as well as the System itself can be pre-planned and maintained.

III. Executive Component

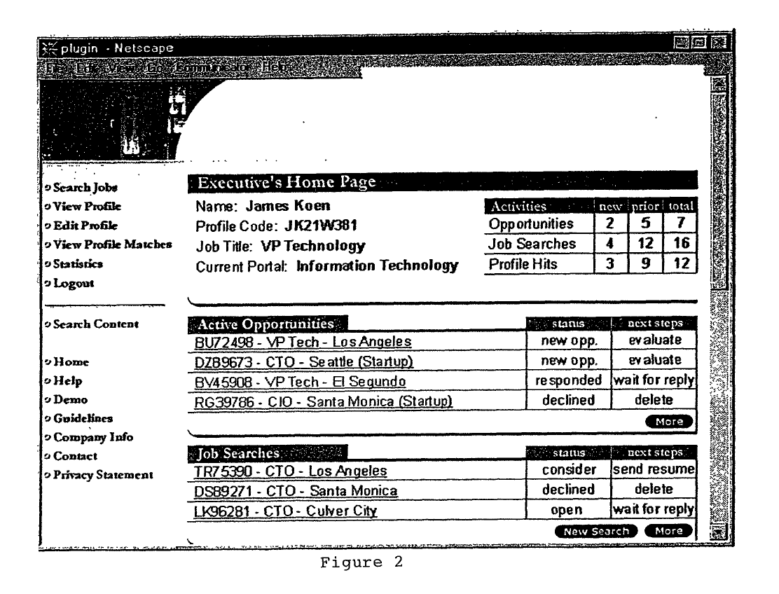

FIG. 2 illustrates a sample Executive Home Page that provides access to the Executive Component 140. The Executive Component allows executives to access the System 100. An executive has access to a variety of resources via the Executive Component 140. Through the Executive Component 140, an executive can create, view and edit an Executive Profile 145, append a resume to his or her Executive Profile 145, apply for a particular job, access work-related bulletin board, and access a peer-supported question and answer chat board. The executive can also search the posted jobs, access a voice mailbox to hear job descriptions, and review job-related content as well as related support features, such as advice on resume preparation. The Executive Component also maintains statistics on job matches and the related details.

On initial access to the Executive Component 140, the executive selects a specific Community from a list of Communities. The Communities classify various function categories and are used to segregate function-specific elements. For example, the Accounting Community will provide access to a bulletin board specific to accounting executives. The Sales and Marketing Community will provide access to a bulletin board specific to sales and marketing. Additionally, the specific Community will provide access to related content via links to such related web sites.

The Communities permit an executive to focus the time he or she spends on the Executive Component 140. The executive need not sort through and peruse unrelated or uninteresting web pages in order to arrive at relevant web pages. The Communities also make efficient use of the executive's time because the Executive Profiles 145 that the executive completes are customized to his or her functional discipline. For example, an accounting executive interfaces with accounting-specific input pages to create relevant Executive Profile. Appendix 1 illustrates an example Input Instruction Pages for the Accounting Community. The accounting-specific Input Instruction pages contain items specific to accounting functions and do not contain generic and unhelpful questions directed to job applicants in general. Such segregation of function-specific elements into Communities greatly streamlines both the executive's and the recruiter's time and increases the probability of a successful match of a job posting with a particular executive. It also permits marketing of services and products that are more focused on the needs and the responsibilities of the executives within the specific communities.

While not required to do so, an executive may choose to create an Executive Profile 145. As noted above, an Executive Profile is a detailed, function-specific questionnaire that captures the relevant, job-specific information that is eventually gathered during an interview process in a traditional job search process. The information gathered by the Executive Profiles is unique information that is not typically included in a resume and information that is, if at all, obtained during an effective pre-screening process or an interview. The Executive Profiles are customized and differentiated for different Communities to maximize their value and effectiveness in matching executives with job postings and are created upon completion of the Instruction Pages. Upon completing the Input Instruction Pages, the System creates an associated Executive Profile and assigns a unique number to the Executive Profile. An exemplary Executive Profile is shown as Appendix 2. The use of the Executive Profiles saves time for all parties involved and greatly improves the effectiveness of the recruitment process.

Improvement in the recruitment process by the use of the Executive Profiles is further enhanced via the use of multiple designations of both the job titles and the industries. Job titles can be confusing and misleading since a similar position can have different titles at different companies. Furthermore, a particular job title can entail significantly different job responsibilities at different companies. For example, an executive can be serving as the chief financial person in his or her company while holding a title of VP Finance and Administration. In such a case, just listing his or her actual title of VP Finance and Administration would not accurately reflect the fact that the executive is actually serving the generic function of a Chief Financial Officer (CFO) in his or her current company. This type of miscategorization often leads to mismatches or ineffective matches. In a preferred embodiment, an executive is prompted to select a generic job title from a list provided by the System and also to provide an actual job title that the executive holds. If appropriate, the executive can select from the list provided by the System for both the generic and the actual job title. This dual designation of job titles ensures proper matching and avoids mismatches frequently resulting from the differing meanings attached to job titles.

In a similar fashion, the industry designation can be confusing as well. Moreover, a significant amount of overlap in the industries may contribute to the confusion. For example, the computer industry can encompass hardware, software, networking, e-commerce, and consumer electronics, with each of these categories further comprising subcategories. To further compound the confusion, an executive often possesses work experience in more than one industry. In a preferred embodiment, an executive is prompted to select a primary industry from a list provided by the System and to provide a specific industry that the executive feels is most appropriate. As in the case of job titles, the probability of proper matching is maximized and mismatches are minimized. Likewise, a recruiter specifies both a generic and an actual job title as well as a primary and a specific industry in posting a job description or searching the Executive Profiles.

The executive who completes an Executive Profile 145 will be able to store his or her Executive Profile in the Database 190 to enable the System to perform matching of job postings with his or her Executive Profile and to be notified when matches occur. However, regardless of whether or not he or she created an Executive Profile, the executive can search the job postings. If any job postings are of interest to him or her, the executive can select those job postings and request the Resource Consultant Component 130 to forward his or her resume to the appropriate recruiter. This request can be made via an email or a telephone call and will include the appropriate job code reference number associated with the particular job postings. On the other hand, the executive can complete an Executive Profile to forward only the job-specific details to the recruiter with no personal data, such as his or her name, address, or current employer being disclosed.

In addition to completing an Executive Profile 145, an executive may choose to append his or her existing resume to the Profile. Providing the resume is optional and is not required to use the System. The executive can choose an option to automatically forward the resume to the recruiter whose job posting matches the executive's Executive Profile.

The Executive Component 140 incorporates two levels of security. Certain features of the Executive Component require a user ID and a password to access while others do not. Features of the Executive Component which implicate some data personal to a particular executive require both a user ID and a password. For example, an executive will need both a user ID and a password to create or modify his or her Executive Profile since the Profile contains data personal and specific to him or her and no one else should be able to modify such data. Likewise, an executive will need a user ID and a password to append a resume to his or her Profile as well as to post questions on the chat board and to participate in the bulletin board.

On the other hand, certain other features do not require a user ID and a password to access. Features which do not implicate personal data do not require a user ID and a password to access. Such features include searching the posted jobs, listening to job descriptions, reviewing job-related content and related support features such as advice on resume preparation.

The executive can also access detailed statistics on the matches and current status of any of the on-going job search via the Executive Component 140. For example, the executive can obtain information on which positions have been matched with his or her Executive Profile 145 and what actions he or she took on those matches. As shown in FIG. 2, the executive can see at a glance that one match is under consideration while he or she declined to pursue another match, for example.

An executive can also access the Executive Component 140 to establish personal contact with a Resource Consultant. Such contact can be made electronically via an email to the Resource Consultant Component 130 or via a telephone call. Likewise, the Resource Consultant Component 130 can respond to the contact via an email or via a telephone call. This feature is implemented to provide alternate channels of communication between the executive and the System 100.

Executive Profiles 145, bulletin board postings, questions and answer postings to the chat board are all stored on the Database Component 190.

IV. Recruiter Component

FIG. 4 illustrates a sample Recruiter Home Page. The Recruiter Component 150 allows recruiters to access the System 100. The access to the Recruiter Component is controlled, and a recruiter needs both a user ID and a password to gain access to the Recruiter Component of the System.

Upon accessing the Recruiter Component 150, the recruiter has variety of options. For example, the recruiter can post a text description of the job, make a voice recording of the job description, enter search criteria to match the job posting with the Executive Profiles 145, view Executive Profiles which matched the search criteria, select matched executives, access recruiter support services, and view related content.

The recruiter generally initiates a search for an executive by entering search criteria or by posting a text description of the job. The recruiter can enter the search criteria using a database-search template or can post a text description of the job using a job-posting template. If the recruiter posts a text description, he or she has an additional option to record a voice recording that provides additional details about the opportunity. An exemplary database-search template is shown as an Appendix 3 and an exemplary job-posting template is shown as an Appendix 4. Both the database-search template and the job-posting template are used by the recruiter to describe particular employment opportunity. Upon completing a database-search template or a job-posting template, the recruiter obtains a job code reference number identifying the particular job opportunity. The job code reference number is fully selectable and customizable by the recruiter.

The recruiter may choose to use a number that is internal to recruiter's operation. For example, the recruiter may already be tracking various employment opportunities using a requisition number uniquely identifying the recruiter's client employer and the particular assignment from the employer. In such situations, it is much more convenient and meaningful for the recruiter to be able to use the same requisition number to track the recruitment effort on the System. The System, in turn, checks and confirms that the job code reference number chosen by the recruiter is available for use by the recruiter to identify a particular employment opportunity.

The System verifies that the job code reference number chosen by the recruiter is unique since the number is used to track all activities related to that particular employment opportunity. For example, the job code reference number is the point of reference to which the matched executives can refer to find out additional details on the employment opportunity. Additionally, the unique job code reference number allows the recruiter to keep track of multiple employment opportunities at the same time. Furthermore, the unique job code reference number facilitates reiterative database searches of the existing Executive Profiles. For example, a recruiter need not enter the same set of search criteria repeatedly each time he or she wants to search the Executive Profiles. The recruiter can enter the unique job code reference number to search the Executive Profiles subsequent days and to modify the search criteria, for example. Being able to track an employment opportunity using a specific job code reference number greatly improves the recruiter's efficiency.

To facilitate searching the Executive Profiles stored on the Database 190, the recruiter can use the database-search template by entering the following searchable criteria, for example:

Functional Community=Accounting;

Job Title=Chief financial executive;

Industry Experience=Technology (Telecommunications);

Skills and Experience=Five years SEC with recent IPO;

Education & Qualifications=MBA, CPA;

Salary=$200,000-$250,000

Specifying these search criteria will result in matching of all the executives whose Executive Profiles include these criteria. Obviously, the fewer the number of search criteria entered by the recruiter, the greater the number of Executive Profiles that will be matched. However, the list of the executives so matched can be over-inclusive and the matched result will be less accurate than the match resulting from using a larger number of search criteria.

Once the recruiter obtains a list of executives whose Executive Profile 145 matches the specified criteria of the job description, he or she can choose to send notifications automatically by the System 100 via an email to all executives whose Executive Profile match the specified search criteria without reviewing the matched list first and selecting therefrom or he or she may only send notifications to the selected executives. This automatic matching and notification are handled by the Notification Component 170 discussed below.

To facilitate posting a text job description, the recruiter can use the job-posting template by entering the following criteria, for example:

Job Title=Chief Accounting Manager (CFO)

Salary=$200,000-$250,000

Industry=Technology (Telecommunications)

Location=Chicago

Company=A $300 million manufacturer/distributor of telecommunications products specializing in the hospitality and Small Office/Home Office (SOHO) markets largely in the Great Lakes region.

Responsibilities=Develop and implement marketing strategy.

Skills and Experience=Ten years mid-sized manufacturing company with a background in developing high tech marketing strategy of telecommunications products through international resellers. Requires fluency in English and French.

Education & Qualifications=MBA, CMA

As in the case of using the database-search template, specifying these search criteria will result in matching of all the executives whose Executive Profiles include these criteria.

Optionally, in addition to text description, the recruiter can choose to make a voice recording of the job description. If the recruiter chooses to make such a recording, the System connects the recruiter to a telephone voice mailbox. The recruiter can then make a new recording, change an existing recording or delete an existing recording of any job description that he or she recorded.

If the recruiter chooses to record a verbal job description, an executive will be able to hear as well as read a job description either through a voice mailbox accessed by their telephone or through a direct online computerized link if the executive's computer supports such voice data. Such added feature will provide a recruiter with an additional opportunity to promote a particular job posting or to highlight any special aspects of the job. Similarly, the executives have access to all the verbal job descriptions to aid them in their job search.

The Recruiter Component 150 also provides access to a variety of recruiter support services including research functions, establishing affiliations, accessing a recruiter-specific bulletin board, and viewing employment opportunities for recruiters.

A recruiter can access the Recruiter Component 150 to obtain support services such as research functions. Small to mid-sized recruiters are usually too small to develop and maintain sophisticated systems and substantial databases of candidates to fill open employment opportunities. Consequently, they either employ researchers in-house or employ independent researchers at considerable cost to find candidates for their clients. The Recruiter Component provides access to a Resource Consultant who will arrange for the appropriate research needs to be fulfilled at a much lower price. Research functions can be achieved at a much lower price since the research functions are aggregated and centralized. This allows the small to mid-sized recruiters to more effectively compete with the large recruiting firms.

Additionally, recruiters can seek and establish various affiliations both nationally and internationally with other recruiters via the Recruiter Component 150, if they choose to do so. Affiliations can provide networking opportunities and peer support, for example. The recruiters can also access bulletin boards specifically utilized by recruiters for a variety of reasons such as to foster networking opportunities as well as to exchange information. Furthermore, the Recruiter Component will be a source of employment opportunities for the recruiters themselves because the Component provides access to a list of recruiter opportunities across the globe.

Furthermore, the recruiters also have access to view related content on the Recruiter Component Home Page. For example, the recruiter may access other related web sites via the provided links to access information such as interview questions list and industry salary surveys.

All information including text description of the job opening, the search criteria specific to any job postings, bulletin board postings, recruiter job opportunities, as well as email notifications to the executives will be stored on the Database Component 190. Any such changes to the information will result in appropriate updates to the database.

V. Notification Component

The Notification Component 170 is a component of the System 100 which performs the automatic matching process. As noted earlier, the matching of the job postings and the Executive Profiles 145 can be initiated manually by either the executive or by the recruiter. Manual matching occurs when either the executive or the recruiter initiates a search to find matches. On the other hand, the matching process can also be performed automatically by the System 100 via the Notification Component.

The automatic matching process is performed to provide the latest update to both the executive and the recruiter. Since the matching process is performed automatically on a periodic basis, both the executive and the recruiter will be assured of having the latest job posting being reviewed without specifically having to manually initiate a search. The Notification Component 170 will automatically compare all new job postings with all Executive Profiles 145 and automatically notify the appropriate executive and the recruiter that a match was found. This will ensure that an existing Executive Profile will always be compared with any new job postings providing a great benefit and convenience to the executive. Likewise, this will also ensure that a recruiter's job posting will always be compared against any new Executive Profiles providing a great benefit and convenience to the recruiter. The period within which automatic comparison is performed can be set and modified by a Resource Consultant possessing the appropriated privilege.

The Notification Component 170 accesses the Database Component 190 to extract the new job postings and the new Executive Profiles posted since the last time a comparison was made. The Notification Component then compares the job postings and the Executive Profiles to find matches. Upon finding any matches, the Notification Component will automatically notify the appropriate executive and the recruiter.

VI. Executive Reply Component

The Executive Reply Component 180 allows the executive selected by a recruiter to respond to the notification that he or she received. The Executive Reply Component also allows the selected executive to seek additional information regarding the matched employment position. The selected executive can respond to the notification without disclosing his or her identity to maintain anonymity.

As described above, the executives can be automatically notified by the Notification Component 170 if a recruiter selects the automatic notification option. On the other hand, if the recruiter does not select the automatic notification option, the recruiter can examine the matches and manually select the executives he or she wants the System 100 to notify. Once the recruiter makes such a selection, the Executive Reply Component 180 notifies manually-selected executives. The responses made by the executives to these notifications are also handled by the Executive Reply Component.

The Executive Reply Component 180 initially sends an email to the selected executives upon the recruiter's selection of the executive. The email informs the receiving executive of the match and provides the executive with the job reference code number so that he or she can look up additional details in the text description and hear a recorded verbal job description, if a recording was made. The email will also inform the executive that his or her resume will automatically be forwarded to the recruiter if a resume has been provided and if the executive has previously checked off the automatic resume forwarding option. If the executive has not previously agreed to have his or her resume automatically forwarded, he or she is requested to call to discuss the employment opportunity with a Resource Consultant. If a resume is not on file, the Executive Reply Component 180 will request the executive to forward a resume to the System 100 if he or she is interested in pursuing the position and to call to discuss the job opportunity with a Resource Consultant.

After reading the email notification, the executive can choose to do nothing or can choose to pursue the position. If the executive chooses to pursue the position, he or she can authorize the release of his or her resume. The executive's authorization to release the resume will be transmitted to the System 100 by the Executive Reply Component 180.

Upon receiving a notification from the Executive Reply Component 180 that the executive is interested in pursuing the position, an email is sent to the executive requesting that the executive contact a Resource Consultant who will review the executive's resume and the Executive Profile 145 with the executive. This step ensures integrity and accuracy of the information provided by the executive to the System 100 to deliver high-quality matching services to the recruiters and to the executives.

VII. Employer Component

The Employer Component 160 allows employers to access the System 100. The System provides a variety of resources to employers. An employer can learn about recruiting and interviewing techniques and can request additional information such as printed booklets outlining successful recruiting procedures and other helpful suggestions from the System. The request can be made to the System in a variety of ways including a phone call or an email. The System can likewise respond to the request in a variety of ways including sending the appropriate booklet via an email or via regular mail.

The Employer Component 160 allows employers to access the System to select from a list of recruiters. The employer can make its own selection from the available list or can request assistance from the System in identifying and selecting an appropriate recruiter. The request can be made to the System and responded to by the System via an email, a fax, regular mail, or a telephone call.

VIII. Database Component

All data created or modified on the System 100 including, for example, Executive Profiles 145, job postings, search criteria, bulletin board postings, and chat board questions and answers are stored on the Database Component 190. Any changes to these data will result in appropriate updates to the appropriate database record in the Database Component 190.

IX. Conclusion

Although the invention has been described in terms of certain preferred embodiments, other embodiments that will be apparent to those of ordinary skill in the art, including embodiments which do not provide all of the features and advantages set forth herein, are also within the scope of this invention. Accordingly, the scope of the invention is defined by the claims that follow. In the claims, a portion shall include greater than none and up to the whole of a thing; encryption of a thing shall include encryption of a portion of the thing. In method claims, reference characters are used for convenience of description only, and do not indicate a particular order for performing a method.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. An Internet-based employment recruitment system, comprising:
a job-seeker component that permits job-seekers to access the employment recruitment system, the job-seeker interface enabling the job-seekers to access information regarding available employment positions and to enter information regarding the skills and experiences of the job-seekers as profiles for the job-seekers;
a recruiter component that permits recruiters to access the employment recruitment system to enable the recruiters to enter information regarding available employment positions from employers and to search the employment recruitment system for potential candidates for the employers;
a resource consultant component that permits resource consultants to access the employment recruitment system to enable the resource consultants to obtain information regarding requirements for employment positions and to obtain information regarding job-seekers profiles and their resumes, the resource consultants further enabled to enter additional information obtained from interviews with job-seekers whose profiles initially match with at least one employment position;
a database component that stores the information comprising the employment positions, the job-seeker profiles, the resumes, and the additional information obtained from interviews;
a notification component that accesses the database component to compare employment positions with job-seeker profiles, the notification system sending a notification to a matched job-seeker when an employment position matches the job-seeker's profile, the notification sent to the matched job-seeker including security to maintain the identity of the recruiters and potential employers in confidence from the selected job-seeker until the recruiters and potential employers authorize the release of recruiters' and the potential employers' identities; and
an executive reply component that permits the selected job-seeker to respond to a notification and to seek further information regarding the employment position, the job-seeker reply component including security to maintain the identity of the selected job-seeker in confidence from the recruiters and the potential employers until the selected job-seeker authorizes the release of the selected job-seeker's identity to the recruiters and potential employers.

2. A system as claimed in claim 1, wherein the information included in the profiles of job-seekers is customizable by the resource consultants.

3. A system as claimed in claim 1, wherein the profile of a job-seeker includes information regarding specific characteristics of a job-seeker's prior employment in response to inquiries from potential employers or the job-seeker's industry.

4. A system as claimed in claim 1, further comprising an employer component that permits the potential employers to access the employment recruitment system to enable the potential employers to access and select among the recruiters.

5. A system as claimed in claim 1, wherein a job code reference number is 15 utilized for the recruiters to enter the information regarding available employment positions and to search the database component.

6. A system as claimed in claim 1, wherein the job-seeker component further comprises detailed statistics on matches and on the current status of the jobseeker's job search.

7. A detailed, skills-specific profile comprising:
customized information relating to a job-seeker's work experience wherein the information is differentiated for various industries;
dual job titles specifying both a generic job title and an actual job title wherein the generic job title is selected from a list; and
dual industry designations specifying both a primary industry and a specific industry, wherein the primary industry is selected from a list.

8. A profile as claimed in claim 7, wherein the profiles are stored on a database and a recruiter can search the database without determining the identity of a job-seeker whose profile the recruiter is searching.

9. A method of matching employment opportunity of an employer with a job-seeker, the method comprising:
storing customized information relating to a job-seeker's work experience as a profile in a database, wherein the work experience includes dual job titles specifying both a generic job title and an actual job title, as well as a dual industry designation specifying both a primary industry and a specific industry;
searching the profiles in the database without knowing the identity of the job-seeker;
notifying the job-seeker identified by the search;
investigating the employment opportunity without knowing a recruiter's and the employer's identity;
disclosing the identity of the job-seeker only upon the job-seeker's authorization;
disclosing the identity of the recruiter only upon the recruiter's authorization; and
disclosing the identity of the employer only upon the employer's authorization.

10. A method as claimed in claim 9, wherein searching the profiles in the database is automatically performed on a periodic basis.

11. A method as claimed in claim 9, wherein the notice to the job-seeker is automatic.
